(19) United States
(12) Patent Application Publication
(10) Pub. No.: US 2005/0254548 A1
(43) Pub. Date: Nov. 17, 2005

(54) Method and apparatus for monitoring a technical installation, especially for carrying out diagnosis

(76) Inventors: Mirko Appel, Munchen (DE); Wolfgang Fick, Munchen (DE); Uwe Gerk, Frensdorf (DE)

Correspondence Address: Siemens Corporation;Intellectual Property Department, 170 Wood Avenue South, Iselin, NJ, 08830, US

(21) Appl. No.: 10/528,315

(22) PCT Filed: Nov. 7, 2002
(86) PCT No.: PCT/EP02/12447

§ 371 Date: Mar. 17, 2005

(30) Foreign Application Priority Data
Sep. 26, 2002 (EP) 02021497.9

(51) Int. Cl. G01N 17/00; G01N 25/72; G01N 3/60

(52) U.S. Cl. 374/57; 374/4; 374/121

(57) ABSTRACT

According to the invention, a temperature pattern representing a current operating situation is derived from and classified by means of measured temperature values and/or other temperature information related to the technical installation.

### CROSS REFERENCE TO RELATED APPLICATION

This application is the US National Stage of International Application No. PCT/EP2002/012447, filed Nov. 7, 2002 and claims the benefit thereof. The International Application claims the benefits of European Patent application No. 02021497.9 EP filed Sep. 26, 2002, both of the applications are incorporated by reference herein in their entirety.

### FIELD OF THE INVENTION

The invention relates to a method and apparatus for monitoring a technical installation.

### BACKGROUND OF THE INVENTION

Conventional approaches to monitoring the operational state of a plant often include acquiring a huge amount of data which are fed into a control system and analysed according to a violation of certain upper or lower limits; e.g. it is checked, if a measured temperature value is lower or higher than a given temperature limit.

This means that in general, each measured value is checked separately for the a.m. violation. Usually, the upper and lower limits are set very close to a potential serious operating scenario so that a limit violation of one or more measured values often require an instant emergency handling, e.g. an emergency stop, to avoid human and/or machinery damage.

Thus, known methods of monitoring a plant are not useful for predicting failures which are still in their process to develop, but have not yet fully developed.

Furthermore, different condition monitoring sources are used to enable power plant monitoring, e.g. vibration monitoring of turbines and/or generators.

These, mostly insular, solutions provide data sets (in most cases not even compatible to each other, especially if different providers for monitoring equipment are involved) which need to be further interpreted for proper condition assessment.

Known methods of thermography utilise measured surface temperatures of a plant's components for condition monitoring purposes (if those surfaces are accessible). Unusual high temperatures on the surface of a machine may for example indicate an electrical failure inside the machine.

Known Thermo-couplers are used for measuring selected temperatures for condition monitoring and process control and conclusions are drawn from individual measurements, e.g. the before mentioned violation of upper and/or lower limits.

### SUMMARY OF THE INVENTION

It is therefore an object of this invention to provide an improved method respectively apparatus for monitoring a technical installation, especially for carrying out diagnosis.

Especially predicting and diagnosing of potential failures of technical installations, especially for turbines and/or generators of power plants shall be very reliable to improve process control.

A solution according to the invention is provided as set forth in claim 1 respectively 3.

Preferred embodiments are laid down in the related dependent claims.

A temperature pattern may include all or part of all temperature values and/or temperature information related to the technical installation.

The derivation of the temperature pattern may include a data compressing algorithm, e.g. a pattern recognition algorithm, so that the amount of data describing said temperature pattern is reduced compared to the amount of temperature data used for deriving said temperature pattern.

The invention is based on the fact that all machinery within a plant and the materials which are being processed give off heat.

In each case the heat is conducted for example to the surface of the object where it is lost to the surroundings by radiation and convection.

Thus, the process of generation and dissipation of heat gives rise to a temperature pattern, e.g. on the surface of a monitored plant component, which is characteristic of the operating conditions at any time. When the operating conditions are changed, the related temperature pattern(s) will also change.

The invention may e.g. include by a imaging system which generates a map of temperatures which are related to a plant component. Such a map will help understand the various operating conditions of one or more plant components, ranging from normal to extremely abnormal operating conditions.

In a testing phase, a.m. temperature patterns of normal and various abnormal operating conditions may be acquired and stored for future reference and comparison with real operating conditions. Thus, a history of temperature patterns related to various operating conditions may help to judge a current operating mode. Even situation in between a normal and abnormal operating mode may be detected and identified well before actual problems and/or dangers arise.

Preferably, temperatures of one or more plant components are acquired in a non-contact matter, e.g. by using an infrared camera.

In another preferred embodiment a huge range of components are checked thermographically, e.g. cables, conductors, switchgear, lighting systems, insulation of buildings, heating systems, pipes, drives, motors, generators, turbines etc.

Loose electrical connections, worn bearings or misaligned couplings can be spotted easily, because their temperature profile will appear exceptionally hot compared to their desired operating temperature patterns, whereas blocked steam pipes or heat exchangers will show an unusual cool temperature pattern when their respective temperature radiation are scanned.

All the examples of faulty plant equipment could not be detected by a visual inspection.

When not only a temperature profile/pattern of one or more isolated plant components are acquired, e.g. via a infrared camera scan, but the temperature pattern of (more or less) the whole plant, the acquired image represents an overall operating mode and necessary action may be taken. Furthermore, a significant reduction of data to be acquired can be achieved compared to acquiring isolated temperature profiles/patterns for single components of the plant as, for example, in many cases it will not be necessary to locate a potential failure with regard to the respective component of the plant and its exact location within or at the component, but it will be sufficient to identify a defective component. Further actions to go deeper into the details of a component's failure are often not very demanding for skilled maintenance engineers and further technical aids are not necessary; more important is the identification of a component turning faulty, if possible, well ahead before said failure causes problems.

Another aspect of the a.m. achievable data reduction according to the invention is the fact that within a plant, many plant components interact and so a faulty first component showing an abnormal temperature pattern often causes the occurrence of a failure in a second plant component, which also shows an abnormal temperature pattern caused by said faulty first component. Such expert knowledge of interaction between plant components can be advantageously used for reducing the amount of data to be acquired in connection with the invention, e.g. by simply avoiding temperature data acquisition of a second component connected “downstream” to a first component as the failure of the second component depends on the occurrence of the first component's failure.

Therefore, temperature data acquisition with regard to said second component is redundant, especially for identifying the underlying basic failure, and can be avoided.

In contrast, known methods and thermography systems heavily focus on individual diagnosis of components, which are judged separately.

The acquired thermographic pictures, preferably related to (nearly) the whole plant or at least to one or more interacting sub-systems comprising a number of plant components, can be fed into an evaluation and analysing system for judgement by e.g. comparing the acquired pictures with stored pictures of a comparable operating situation. The results can be used for planning and carrying out of necessary maintenance and service work.

The present invention combines thermal information (temperature pattern(s)) which includes temperature information related not only to some isolated components of the plant but to as many components of the plant as possible, taking into consideration interactions between plant components and their respective “failure dependence”, as described earlier.

All acquired measured values of temperatures of a technical installation's components, e.g. surface temperatures of turbine housings, bearings, boilers, pumps, pipes, cables, switchgears, generators etc. can be stored in a common database (or be linked to each other to obtain a real temperature pattern).

Current and/or historic failures (and/or other process disturbances, which are often pre-scenarios of future failures or which may just be temporal and tolerable deviations of a normal operating situation) are related to specific temperature patterns derived from a.m. acquired measured values of temperatures; said patterns are constantly being refined, manually and/or automatically e.g. by employing expert systems, in the course of time during operation of the plant to achieve adaptive monitoring including a learning process.

When a particular temperature pattern is detected again, failure prediction can be made, especially based on comparable historic situations stored in the a.m. database.

Temperature patterns related to process disturbances can be distinguished from the ones related to failures and may be utilised for process optimisation and feedback to process enhancement.

The present invention includes, but is not limited to, the following advantages:
no inhomogeneous data sources for failure prediction and process control
limitations of known thermography and selective temperature measurements are no longer applicable
cost advantage compared to a combination of conventional condition monitoring systems
clear distinction between failure and process disturbance
feedback to process control possible

### BRIEF DESCRIPTION OF THE DRAWINGS

The following figures illustrate preferred embodiments of the invention.

FIG. 1 an apparatus according to the invention, and

FIG. 2 a pumping system for diagnosis by a method according to the invention.

### DETAILED DESCRIPTION OF THE INVENTION

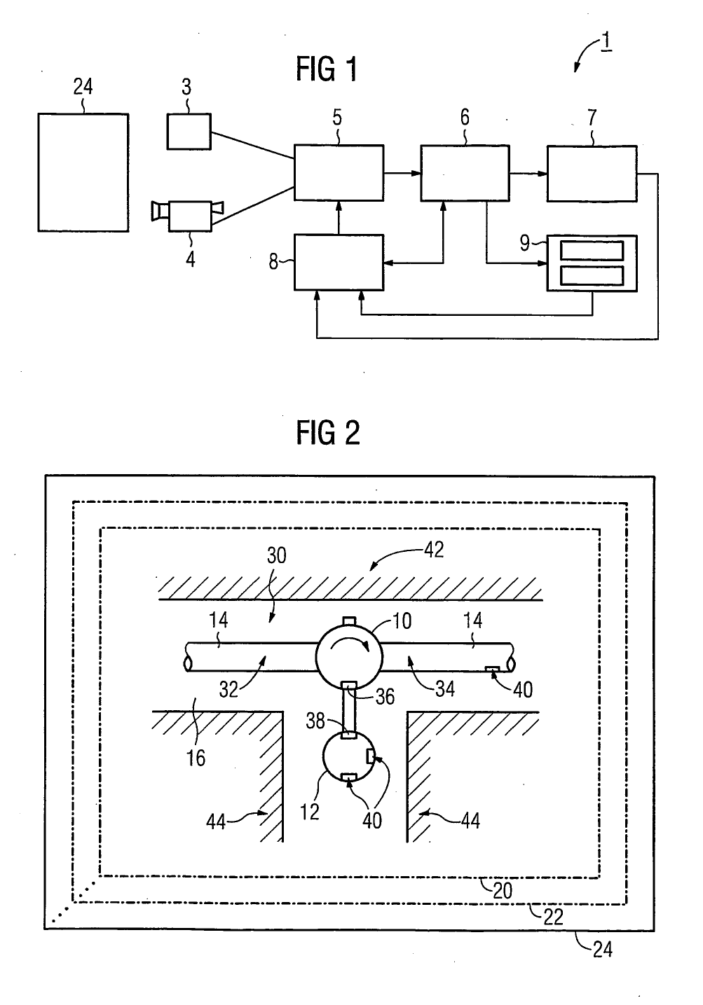

In FIG. 1, a typical configuration of an apparatus 1 according to the invention is shown.

A technical installation 24, e.g. a power plant, shall be monitored.

The technical installation 24 comprises a number of systems 22 and subsystems 24, which at least partly interact.

During operation, at least some of the a.m. components of the technical installation 24 produce heat at several locations.

Monitoring and diagnosing of the technical installation by the apparatus 1 is carried out by acquiring temperature values and temperature information related to the technical installation 24 and its current operating situation.

Temperature values may be gained by means of a sensor unit 3 and/or a connection to an existing control system of the technical installation 24, where acquired temperature values are processed.

Other temperature information such as a heat profile comprising one or more thermographic pictures is collected by an infrared camera 4.

The a.m. temperature data are inputted into a data acquisition module 5, which is connected to an analysis module 6.

The analysis module 6 includes a pattern recognition algorithm to derive a temperature pattern 7 of the technical installation 24 from the a.m. temperature data; the temperature pattern 7 corresponds to a current operating situation of the technical installation 24 and may include a graphical, preferably a two- and/or three-dimensional, representation and/or a textual representation and/or table-wise structured information etc. thereof.

For classifying the current operating situation, the analysis module 6 compares the temperature pattern 7 according to the current operating situation to known temperature patterns 7 corresponding to past and/or hypothetical temperature patterns 7, which are stored in a database 8 and correspond to a known and/or normal and/or abnormal and/or desired operating situations etc.

The result of the a.m. comparison helps classifying the current operating situation and outputting a corresponding classification message 9, e.g. on a computer screen of a plant operator.

The classification message can include identifying the current operating situation as a normal and/or stationary and/or transient and/or desired and/or tolerable and/or abnormal and/or dangerous operating situation of the technical installation 24.

Even if the temperature pattern 7 corresponding to the current operating situation does not perfectly match any of the known temperature patterns 7 stored in the database 8, the analysis module 6 still can classify the current operating situation e.g. by determining the degree of similarity between the current temperature pattern 7 and the a.m. known temperature patterns. Such known temperature pattern(s), which comes closest to the current temperature pattern, can determine the classification of the current operating situation.

The apparatus 1 improves with regard to its classification abilities in a self-adaptive manner, because temperature patterns 7, which have been derived by the analysis module 6 but not yet been stored in the database 8, because of their occurrence for the first time, will be stored in the database 8 together with their related classifications (which may be based on similarity calculations, as stated earlier).

So in the course of time during operation of the technical plant and the apparatus 1, the latter is trained automatically to identify and classify a growing number of different operating situations.

FIG. 2 shows a pumping system as a sub-system 20 of a technical installation 24 for diagnosis by a method according to the invention.

The pumping system is one of a number of subs-systems 20 or systems 22 which are included by the technical installation 24.

The pumping system comprises a pipe 14, a first part of which is connected to an inlet of a pump 10 and a second part of which is connected to an outlet of pump 10, so that a fluid present in pipe 14 is conveyed through pipe 14.

The pump 10 is driven by and coupled to a motor 12.

This whole assembly is mounted within a T-shaped mounting hole 16.

The following temperature values and temperature information related to the pumping system shall be accessible, e.g. for being acquired by a temperature sensor and/or an infrared camera and/or as a calculated value:

An environmental temperature 30 present within the mounting hole 16,
a fluid inlet temperature 32 present at or near the inlet of pump 10,
a fluid outlet temperature 34 present at or near the outlet of pump 10,
a pump bearing temperature 36,
a motor bearing temperature 38,
other temperatures 40 related to pump 10 and/or motor 12 and/or pipe 14, e.g. a surface temperature of pipe 14 and/or motor 12 and/or pump 10, and
at least one thermographic picture of an area 44 located closely to the pumping system.

An area 42, e.g. a (thick) wall, shall not be accessible for acquiring temperature data.

The a.m. list of temperature data can be catagorized as follows:

The fluid inlet 32 respectively outlet temperature 34 are usually acquired and processed by a control system of the technical installation 24 and can therefore be directly obtained via a data connection between said control system and an apparatus 1 according to the invention; no additional measurements etc. are necessary.

The pump 36 respectively motor bearing temperature 38 can, but are usually not processed within the control system and therefore have to be acquired additionally, e.g. by means of temperature sensors and/or thermography equipment, e.g. an infrared camera focussed on said bearing(s); the method of choice depends on the necessary expenses and/or expected results. Those temperatures have been selected for monitoring of the pumping system according to the invention, because they are well suited indicators for the operating situation of the pumping system: a bearing going faulty changes its temperature profile while still keeping its function for a period of time. A failure of the pumping system can therefore be detected well before its actual breaking down.

The environmental temperature 39 and the other temperatures 40 also can, but are usually not processed within the control system and therefore have to be acquired additionally, preferably by means of thermography equipment, e.g. an infrared camera focussed on said areas of interest.

1-6. (canceled)

7. A method for monitoring and carrying out a diagnosis of a technical installation, comprising:
deriving a temperature pattern from a number of temperature values and temperature information related to the technical installation and related to a current operating situation of the technical installation;
comparing the derived temperature pattern to a known failure temperature pattern and a stored failure temperature pattern and a process disturbance temperature pattern related to a specific operating situation of the technical installation; and
classifying the current operating situation as a normal and stationary and transient and tolerable and abnormal and dangerous operating situation of the technical installation based on the comparison.

8. The method according to claim 7, further comprising storing the classification of the current operating situation and its related temperature pattern in a memory, preferably a database, for a future comparison with a future temperature pattern occurring during a future operation of the technical installation.

9. The method according to claim 8, further comprising acquiring the temperature values and temperature information by means of an infrared camera.

10. An apparatus for carrying out diagnosis of a technical installation, comprising:
a data acquisition module adapted to acquire a number of temperature values and temperature information related to the technical installation; and
an analysis module adapted to derive a temperature pattern related to a current operating situation of the technical installation from the temperature values and temperature information, comparing the temperature pattern to a known failure temperature pattern and stored failure temperature pattern and process disturbance temperature pattern related to a specific operating situation of the technical installation and to classify the current operating situation as a normal, stationary, transient, tolerable, abnormal, and dangerous operating situation of the technical installation.

11. The apparatus according to claim 10, further comprising a memory adapted to store the classification of the current operating situation and its related temperature pattern for a future comparison with a future temperature pattern occurring during a future operation of the technical installation.

12. The apparatus according to claim 10, further comprising an infrared camera included by the data acquisition module.

13. The apparatus according to claim 11, wherein the memory is a database.
